(19) United States
(12) Patent Application Publication
(10) Pub. No.: US 2013/0173458 A1
(43) Pub. Date: Jul. 4, 2013

(54) WATER PURIFICATION APPARATUS AND METHOD

(71) Applicants: Alison Hill, Baltimore, MD (US); Mikkel Vestergaard Frandsen, Lausanne (CH)

(72) Inventors: Alison Hill, Baltimore, MD (US); Mikkel Vestergaard Frandsen, Lausanne (CH)

(21) Appl. No.: 13/540,268

(22) Filed: Jul. 2, 2012

Related U.S. Application Data
(60) Provisional application No. 61/503,969, filed on Jul. 1, 2011.

(51) Int. Cl. G06Q 30/00

(52) U.S. Cl. CPC G06Q 30/018
USPC 705/39

(57) ABSTRACT

Method for reducing the carbon footprint of a community by implementation of a water filter project comprises assessment of the viability of a filter system to determine the acceptability of said filter system for implementation in a community as substitute for the sterilization of water by boiling. Filter systems are transported to a community, for example a developing country where water is sterilized by boiling on a routine basis due to the presence of waterborne illnesses. The filter systems are then installed and operated. The volume of water produced by the filtering system is then monitored and usage data is generated and communicated to a database. The volume of carbon credits associated with the usage data is calculated. Information is communicated to a consumer of carbon credits. Funds are then transferred from said consumer to a person or persons, i.e. the project proponent, providing and installing said filter system.

### TECHNICAL FIELD

The invention relates to apparatus and methods for the purification of water in economically disadvantaged areas of the world where current biomass consumption for water boiling causes the emission of carbon and other pollutants, where such may be implemented at year zero cost, zero cost or generate a profit.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Today, nearly 900 million people in the world lack access to safe drinking water. Sixty percent of this population lives in Sub-Saharan Africa and Southern Asia. Without legal access to, or sometimes in the complete absence of, safe water supplies, for example municipal water supplies, many rely on shallow wells, which did not protect against waterborne diseases such as dysentery, and or natural bodies of water which may be polluted on account of proper sewage and sanitation facilities. Accordingly, many treat contaminated water using wood or other biomass fuels to boil the water for a period of time sufficient to kill biological agents responsible for disease. Water boiling is labor and resource intensive and wood to fuel traditional cook stoves is becoming increasingly scarce and expensive in many of these areas. The amount of carbon produced by burning wood is remarkably high. Depending upon density and moisture content, burning 1 kg of wood produces roughly between 2 and 3 kg of carbon dioxide. Given that carbon credits can sell for as much as $15-20 per ton, the payback from investment in alternative potable water supplies can be substantial. Even though the market price may vary greatly, it is expected that such payback will likely generate a profit from the investment.

Due to the relative unavailability of combustible fuels, the consequent dedication of a substantial part of the available labor pool to gathering of fuel causes labor shortages for badly needed economic development. Due to the shrinking of living biomass resulting in reduced carbon dioxide consumption and oxygen emissions, world attention has been focused on the reduction of carbon emissions for many years. Nevertheless, hundreds of millions of people spend significant amounts of time and consume energy in carbon producing water purification activities which remain substantially unaddressed.

Moreover, in addition to carbon production, such activities also have the result of introducing other pollutants into the atmosphere on a remarkably large scale. The situation is complicated where fuels may incorporate processed biomass and manufactured products comprising biomass and chemical products such as glues, coatings and the like.

In many developing counties, baseline energy use is depressed by poverty, lack of infrastructure to support energy creation and access. Therefore, much of Africa and other developing countries have remained at the margins of the carbon market. To address this suppressed demand for energy to undergo activities, like water treatment, the carbon markets have implemented measures to allow developing countries to leapfrog technologies. This allows them to implement clean technologies without first implementing polluting technologies. In the field of water treatment, carbon finance pays for those people that are able to boil water with biomass for treatment as well as those that would boil water if they had resources to do so.

### SUMMARY OF THE INVENTION

It would be advantageous to eliminate the need to boil, and thus decrease the use of wood fuel, relegating it to such activities as cooking and, in certain latitudes, heating. Any progress in achieving these goals would result in reduction of emissions of greenhouse gases and other pollutants, helping to mitigate climate change, improve air quality, and decrease the risk of respiratory infections and water-borne diarrheal diseases.

While, in principle, it is possible to address these issues with existing technology, financial and time costs are significant due to the limited availability of resources. In addition, engineering of a system for distribution and implementation of a technology must take into account human factors to be successful. Moreover, relatively high tech solutions face not only economic implementation obstacles, but also, over the long-term, basic maintenance and other issues which may thwart the goals intended at the time of implementation.

Looking at the broader picture, even low-tech solutions, if implemented through aid to developing countries, may not be utilized, being regarded as introduced by outsiders and unnecessary to a culture which prides itself on being able to take care of itself using traditional methods. In this respect, conventional assistance methodologies may disincentivize people from achieving broader societal objectives, for example, by isolating disadvantaged populations from what would be an uplifting sense of participation in worldwide techno-economic initiatives.

In accordance with the invention, a method is provided for the implementation of infrastructure aimed at reducing biomass fuel consumption. This may be implemented at little or no cost, and in some cases may generate a profit. At the same time, the system is designed to incentivize otherwise largely isolated populations to participate in global initiatives relating to the mitigation of global warming, local air pollution, deforestation and related issues. In accordance with the invention and associated regulatory bodies, the invention must be reliably monitored and audited, allowing the implementation of a carbon credit process which is used to subsidize, pay for or generate a profit from the inventive system.

In accordance with the invention, a method for reducing the carbon footprint of a community by implementation of a water filter project comprises assessing the viability of a filter system to determine the acceptability of said filter system for implementation in a community as a substitute for the sterilization of water by boiling. The filter systems are transported to a community, for example a community in a developing country where water is sterilized by boiling due to the presence of waterborne illnesses.

The filter systems are then installed and operated. The volume of water produced by the filtering system is then monitored and data on adoption and usage is generated and communicated to a database. The volume of carbon credits associated with the usage data is calculated. Based on a comprehensive calculation, incorporating usage and other key variables, the amount of emission reduction resulting from the project is then calculated in the form of tons of CO₂. Each ton of emissions reduction is issued in the form of a carbon credit, which can be sold on international carbon markets to a consumer of carbon credits; either governments, companies or individual consumers that are obligated or choose to offset their own emissions. Funds received from the sale of the carbon credts are transferred from said consumer to the project implementer of the filter system program.

The assessment of the viability of the filter system to determine the acceptability of said filter system for implementation in a community as a substitute for the sterilization of water by boiling may involve assessing initial cost, service cost, unit life and system lifespan in volume of water produced.

The monitoring of the volume of water produced by said filtering system and generating use data may be performed by a mechanical water meter.

The mechanical water meter may be visually inspected periodically by an auditing authority.

The monitoring of the volume of water produced by said filtering system and the generation of use data may be performed by a telemetering subsystem.

The operator of the system may perform monitoring installation and maintenance costs and carbon credits generated to generate cost and carbon credit information, and communicate costs and carbon credit information to a cost and carbon credit information database.

The cost and carbon credit information database may be communicated to information technology infrastructure associated with a carbon credit trading facility. The database used in the inventive method is a monitoring database that provides demographic information on the households and monitors relevant indicators that measure usage, knowledge and consumption but does not monitor information on either costs. While the indicators that are populated in the database are used to calculate carbon credits.

The cost and carbon credit information database may be communicated to or reside in a computing device operated by software which assesses the value of carbon credits produced and compares the same to a threshold based on said cost information to generate a decision as toward whether to continue operation of the project.

The assessment of the viability of a filter system to determine the acceptability of said filter system for implementation in a community as a substitute for the sterilization of water by boiling may be conducted on the basis of community metrics such as population, accessibility, and existing water delivery infrastructure, with reference to community model metrics and profitability associated therewith.

The cost and carbon credit information database may be communicated to or reside in a computing device operated by software which assesses the value of carbon credits produced and compares the same to a threshold based on the cost information and calculates adjustments to the community model metrics.

The adjusted community model metrics may be used in subsequent projects to determine the acceptability of the filter systems for implementation in a community as a substitute for the sterilization of water by boiling.

In accordance with the invention, such household level, zero emission water filter technologies can contribute considerably to global climate protection while playing an important role in improving the health and economic development of many of the least-developed countries. The inventive filter technology methods are a relatively simple point-of-use approach that achieves high standards for water quality and reduces the need for boiling water, thus reducing greenhouse gas (GHG) emissions. Carbon financing offers an economically feasible, scalable and sustainable way to provide water purification to targeted regions with seven to twenty-one year service durations. One must take into account meeting US EPA standards of water quality and meeting WHO guidelines for highly protective.

Leveraging the carbon markets to finance the filter-based water purification methodology of the present invention also contributes to economic development in a number of ways. Access to safe drinking water has a direct impact on economic development and the implementation of the inventive carbon method itself requires local maintenance and repair shops, extensive community education and regular monitoring.

The Gold Standard voluntary market and Kyoto Protocol's Clean Development Mechanism (CDM) are the markets that apply to projects in developing countries and provide the best platform for registration of the inventive filter-based water purification projects. Both of these markets enable trade in carbon reductions between developing and industrialized nations for activities that contribute to sustainable development. CDM enables trade between projects in developing and industrialized nations. The Gold Standard allows trade between projects in developing countries and corporations or other private entities, for example, governments predominantly fall under CDM because they fulfill obligations established under Kyoto. The voluntary markets are predominantly corporations who buy on the marketer voluntarily. With stringent project review and verification requirements and laborious procedures structured to safeguard environmental objectives, participation in the carbon projects can be somewhat commanding, but once registered, the inventive method will provide revenue to provide filter-based water purification for a period of 7-21 years.

Given the magnitude of the emissions involved and the household uses at which the inventive method is directed, these projects have the potential to be among the largest Gold Standard projects in the market. In accordance with the invention, operators distribute the water purification filters. Intensive monitoring and community education may be used to ensure all units are maintained and that recipients are using the technology correctly and consistently. Verifications may be done by third-party auditors every six months or annually, for example, and credits issued to directly reflect appropriate use of the tool. These credits are then sold on the market to private sector or government buyers. If successful, this project will generate substantial revenues over the life of the project. A portion of the revenue may also be used to fund community education, monitoring and maintenance and repair of the units annually while the rest is realized as profit or can be used to scale-up the model.

This is particularly important given that water-borne disease is a leading cause of illness in the developing world, contributing to the death of 24,000 children under the age of five each day. Recent World Health Organization (WHO) reports, estimate the impact of diarrheal disease on children is greater than the combined impact of HIV/AIDS, tuberculosis and malaria.

As alluded to above, access to safe drinking water also has significant impact on the economic health and development goals of countries. The economic benefits of investing in safe drinking-water include health-care savings by health agencies and individuals, productive days gained per year (for those 15-59 years of age), increased school attendance, time savings (working days gained) resulting from more convenient access to services, and value of deaths averted (based on future earnings).

A study conducted by WHO estimated that achieving the water and sanitation Millennium Development Goals (MDG) target alone could bring economic benefits, ranging from US $3-$34 per US dollar invested, depending on the region. Additional improvement in drinking water quality, through point-of-use treatment, if sustained, could increase this return to $5-$60 per US dollar invested.

Despite clear evidence of the benefits to development, countries and donors allocate disproportionately low and poorly targeted resources for improving access to safe water to the populations in greatest need. Due to concerns over sustainability and the complexities of water budgets in traditional foreign aid architecture, effective interventions, tools and technologies are underfunded or not funded at all. These challenges with funding have discouraged technological and programmatic innovation.

When compared to other sectors, particularly the other major social sectors of education and health, sanitation and drinking-water receive a relatively low priority for both foreign development aid and domestic allocations. Despite evidence that safe water plays a vital role in health outcomes and achieving many of the MDGs, the total aid for all aspects of water fell from 8% to 5% of total development aid between 1997 and 2008. During this same period, aid for health increased from 7% to 12%.

### BRIEF DESCRIPTION THE DRAWINGS

The operation of the invention will become apparent from the following description taken in conjunction with the drawings, in which:

FIG. 1 is a flow chart generally illustrating a general implementation of the present invention; and

FIG. 2 is a block diagram illustrating an exemplary embodiment of up infrastructure for implementing the present.

### DETAILED DESCRIPTION OF THE PREFERRED EMBODIMENTS

Filter-based water purification is a point-of-use microbial water treatment system. In accordance with the invention, it is used in routine tasks in low-income settings. A typical filter system can filter up to 18,000 liters of water, enough to supply a family of five with microbiologically clean drinking water for three years, thus removing the need for repeat intervention. Filters are a clean technology and require no electricity or additional consumables beyond the unit itself Filter-based water purification complies with the U.S. Environmental Protection Agency's “Guide Standard and Protocol for Testing Microbiological Water Purifiers,” providing treated water that is as-good or better than boiling from the standpoint of lack of microbiological contamination.

Filter-based water purification reduces the need to boil water for safe consumption. Reduction in boiling directly leads to reduced carbon dioxide emissions. The inventive method abates the use of firewood, thereby reducing the use of non-renewable biomass and in principle, allowing it, as a clean technology, to access the international carbon markets.

The inventive method is used to produce carbon credits for filter-based water purification. The methodology begins with the distribution of filters to a target population free of charge. These filters decrease the need for boiling which translate into wood and other biomass fuel saved. The amount of fuel saved is measured and carbon credits are issued. Industries purchase credits from the operator of the inventive method to offset their own emissions and revenue is used for continued community education, repair and replacement of the filters over time.

Revenue in excess of what is needed to repair or replace the filters can be used to scale-up programs across different regions or countries or realized as profit. Carbon credits issued annually depend on consistent and appropriate use of the filter and actual reduction in boiling practices. Some of the parameters that are monitored to estimate the volume of carbon credits issued annually include daily use of filter-based water purification for water consumed in the home, volume of water filtered, for example per person/household/community per day (which may be implemented by inclusion of metering devices in the water filter systems used), and report or query-based reduction in the practice of boiling drinking water.

Monitoring is done every six months to one year and verified by a third-party auditor. Reduction in boiling and use of firewood is translated into volume of carbon emissions avoided by use of the filter. Total carbon offset is measured as compared to the baseline and carbon credits are issued to the operator of the inventive method after each verification.

Credits are then sold to direct buyers or on an open market. In many cases, Emissions Reductions Purchase Agreements (ERPA) are put in place during project development to secure buyers prior to implementation and thus help to manage risk. Revenue from the sale of the credits may be in part be re-invested into the maintenance and replacement of filter-based water purification units and community education to ensure high uptake of the technology and additional revenue is realized as profit.

Carbon finance water projects can directly link health outcomes to a sustainable financing mechanism to improve access to safe water in least-developed countries. The business model for linking filter technologies to the carbon market is sustainable, scalable within countries with high rates of boiling and deforestation and can decrease the operator of the inventive method's dependence on development aid in these areas.

The inventive carbon finance value chain is a conceptual model of production of carbon emissions averted through clean technology projects. These emissions reductions are measured in credits that can be bought and sold on the carbon market. In accordance with the inventive model, products and services (filter-based water purification units, maintenance, repair, replacement and community education) are “invested” in a carbon finance project, to produce future carbon credits that can be sold for revenue. In this model, revenue only comes in after the project is in place and only pays the company for what they have achieved. The upfront capital investment required to produce carbon credits is substantial and the model can be sensitive to both market and environmental factors.

The development of the Kyoto Protocol and the EU Emissions Trading System has generated a demand for emission reductions, partly met through the use of market-based mechanisms. Carbon credits can be earned by producing fewer greenhouse gases (GHG) with modern, more efficient technologies in order to advance social and economic development.

Carbon markets can be defined as project-based compliance markets which trade emissions credits acquired from GHG emissions reduction projects. The so-called clean development mechanism (CDM) allows projects set up in developing countries to reduce greenhouse gas emissions and generate tradable credits. In accordance with the invention, joint implementation allows developed countries, particularly those in transition to a market economy, to host carbon-reducing projects funded by another developed country.

Other carbon markets form what is known as the voluntary market. These provide companies, individuals and other entities with options to acquire emissions reductions that are not subject to compliance levels or mandatory limitations as set by the Kyoto Protocol.

Still another variation is the use of issued verified emissions reductions (VERs).

In accordance with the allowance market, or so-called “Cap and Trade System”, an administrative approach is used to control pollution by providing economic incentives for achieving reductions in the emissions of pollutants.

In addition to the above, the European Union has implemented the regulation of emissions from power generation and other activities.

There are two components of the carbon market that are relevant to the inventive filter-based water purification projects in developing countries; the CDM of the compliance market and the voluntary market through the Gold Standard. The process to acquire credits from the two markets is similar but the buyers of the credits are different. In all markets one carbon credit is equal to 1 ton of carbon dioxide emitted.

Carbon credits arising from Clean Development Mechanism (CDM) projects are known as Certified Emissions Reductions (CERs). Carbon Credits arising from voluntary schemes are called Voluntary Emissions Reductions (VERs)

Compliance Market and Clean Development Mechanism. The major schemes in the compliance market are under 1) the Kyoto Protocol, which commits all developed countries that have ratified the Protocol to reducing an average of 5.2% of 1990 level emissions by 2008-2012, and 2) the European Emissions Trading Scheme (EU ETS) which commits European states to reduce their greenhouse gas emissions. The EU ETS is currently in Phase II which ends in 2012; Phase III of the EU ETS is from 2012-2020. Even though the future of the compliance market under the successor to the Kyoto Protocol is unknown, the EU ETS members have committed to buying carbon credits from projects in Least Developed Countries (LDCs) until 2020.

Certified Emissions Reductions are generated from CDM projects under the United Nations Framework Convention on Climate Change (UNFCCC). The CDM is one flexible mechanism under the Kyoto Protocol that allows developed countries to buy emissions reductions from projects in developing countries. The projects must reduce emissions, contribute to sustainable development and be an additional activity (or activities) to what would occur without the project. The other two mechanisms of the Kyoto Protocol are Joint Implementation, which allows for the purchase of emissions reductions in developed countries (mainly in Eastern European countries) and emissions trading.

Voluntary Market.

Voluntary carbon finance markets exist in parallel with the compliance mechanisms. These markets exist for several reasons, including as mechanisms for corporate social responsibility, in anticipation of further regulation, and, importantly, as incubators for projects and methodologies that may later be integrated into compliance mechanisms.

Voluntary Emission Reduction (VER) buyers generally are purchasing VERs as a corporate or personal interest in directly offsetting emissions caused by their own activities. Highly charismatic projects are ones in which tangible humanitarian benefits are produced in addition to clear emissions reductions. Because of this, they can secure prices comparable, or better than compliance mechanism prices but at lower volumes.

Buyers are attracted to the voluntary market and the Gold Standard specifically because of sustainability benefits, environmental and social benefits beyond additionally, and strong commitment to high quality standards. Quality has become central to players in the voluntary market, even more important than price. The Gold Standard is considered to produce some of the highest quality credits and with rigid monitoring and verification requirements, it is increasingly seen as an incubator for the compliance market.

Additionally means that the project associated with a legitimate carbon credit must be a project which is in addition to what would occur without the carbon credit market in place. It is less important for any carbon credit (offset) to prove additionally. The concept of additionally addresses the question of whether the project would have happened anyway, even in the absence of revenue from carbon credits.

Only carbon credits from projects that are “additional to” the business-as-usual scenario represent a net environmental benefit. Carbon projects that yield strong financial returns even in the absence of revenue from carbon credits; or that are compelled by regulations; or that represent common practice in an industry, are usually not considered additional, although a full determination of additionally requires specialist's review and judgment.

Methodologies are the platform through which projects can register for carbon finance. A methodology clarifies the approved procedures to determine emission reductions from a project activity over time, including the methodology's eligibility criteria, the emission baseline, and monitoring requirements. Development of new methodologies is thus important to the development and expanded reach of the CDM but must be done carefully to preserve the highest quality standards and prevent low quality technologies from accessing the market.

Currently, applications to water technologies have been subsumed under the umbrella of cook stove methodologies. The first cook stove methodology AMS II.G, was approved in February 2008 as the first small-scale methodology under the CDM to assess baseline and monitoring for activities promoting energy efficiency in biomass use through cook stoves. Since that time, other CDM methodologies have been approved including the I.E. methodology which indirectly applies to water treatment, through the reduced use of biomass for water treatment through boiling. In June 2008, a Gold Standard methodology for large-scale cook stove projects was approved and then modified in early 2010 to include an explicit application for water technologies. Currently there are water projects that are pending approval by the CDM Executive Board and Gold Standard Foundation, but there are no existing approved water projects on the carbon market.

The product being sold in the business model associated with the inventive method is carbon credits. However, the volume of carbon credits issued to the operator of the inventive method annually is directly linked to the low or zero emission technologies used for each carbon project.

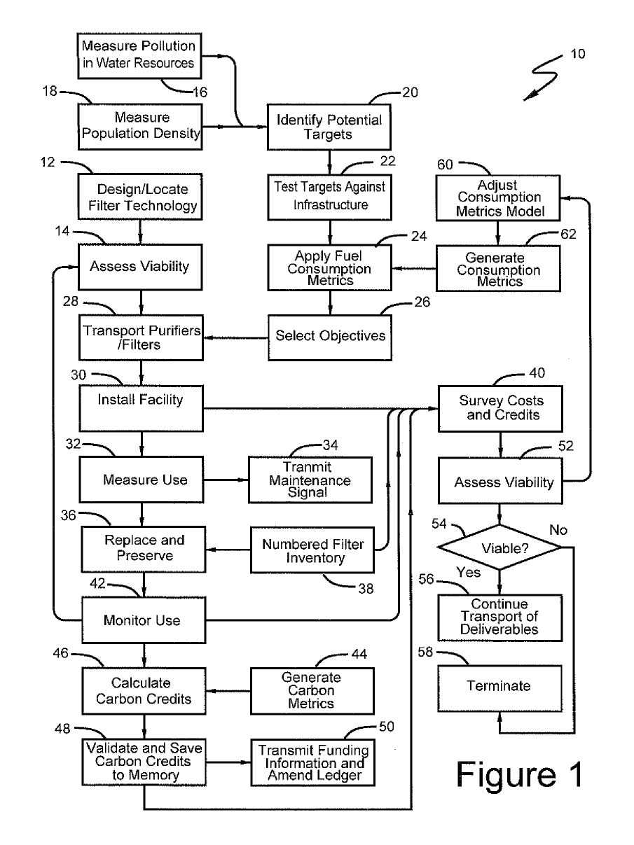

Turning to FIG. 1, the method of the present invention may be understood. Method 10 comprises the design of appropriate filter technology or location of the same at step 12. Desirable characteristics include low initial cost, longevity and overall economy, reliability, simplicity to service and volume. At step 14, these characteristics are assessed against a potential project, looking at the number of people to be serviced, skill levels, system setup and transport costs, costs associated with audit of project performance and the like.

At step 16, the selection of potential project locations is begun with an assessment of pollution in water resources in areas known to have high density of waterborne diseases. In so far as the cost of water filters may only be covered if there is sufficient usage of the same, it is important that population density in the area to be served by the project be sufficiently high. This allows relatively rapid use of the filters and allows the installation of many filters in a given area, thus reducing audit costs. Such assessment of population is done at step 18.

Generally, in accordance with the present invention, it is considered that areas where microbiological water pollution is more severe are likely to see more use of the filter system than areas where waterborne diseases are less of a problem. Accordingly, the degree and nature of water pollution is measured and used in the assessment and identification of potential project locations of step 20. Upon the identification of a potential location at step 20, the sufficiency of water delivery infrastructure is tested at step 22. Accessibility, convenience and reliability of the water delivery infrastructure must be sufficiently high that potential users would be encouraged to use the proposed potential filtered water delivery system, assuming existing water infrastructure is in place.

Based on this information, one calculates the volume of water likely to be delivered by the potential project. At step 24, the amount and type of fuels used in the area for the sterilization of water are then assessed, and the carbon output is evaluated from the standpoint of carbon credit generation. The consumption metrics applied at step 24 may be based on expected consumption derived from interviews with the affected or similar populations, and engineering valuations. The above assessment is made for a plurality of proposed project locations and the economic viability of the project is assessed.

At step 26, based on this information, a selection of the most economically viable proposed projects is made. Alternatively, all projects which meet certain threshold criteria may be selected. At step 28, filter systems are transported to the location of each selected project. At step 30, the water filtering system is installed.

Optionally, at step 32, use of the filter may be monitored for purposes of maintenance. At step 34 the need for maintenance bills transmitted, for example, as a reflective indicator which is painted red on a use measurement device, which may be tripped by sufficient water flow. Required work is performed at step 36, for example by replacing the filter at step 38. The cost of replacing the filter and the initial installation costs may be tracked at step 40 for later assessment. Generally, such method has as its objective a determination whether the carbon credits earned by the inventive system will have a value close to or in excess of installation and maintenance costs, whereby the project will be, respectively, heavily subsidized by carbon credits or make a profit, as appears more fully below.

Alternatively, a schedule for maintenance may be provided, or a device not requiring maintenance but merely replacement may be employed.

In accordance with the present invention, the volume of water filtered by the system is monitored at step 42, for example based on qualitative survey based data. Optionally, filters for replacement of fouled filters may come from a numbered filter inventory which may be used as a means to track filter use and, accordingly, the number of carbon credits applicable for sale on the market. Available alternatives for measuring water consumption for the purpose of auditing carbon reduction include a mechanical water meter, cellular telephone coupling to a mechanical water meter for the purpose of telemetering, filter inspection and filter counting. Separate inventory, distribution and monitoring information may alternatively and most desirably be used for this.

However, after the replacement of a filter at step 36 and monitoring of use at step 42, a preliminary viability assessment may be made to determine if the project is performing as expected and whether a decision to continue auditing, optional filter replacement, and so forth is economically justified.

In accordance with an alternative embodiment of the invention, a conventional mechanical water meter, associated with the filter system, may be provided with tamper indicators and periodically visited by an auditor.

Because the amount of wood necessary to sterilize a liter of water is calculated in the baseline, one may calculate a direct relationship between water consumed and the amount of carbon which was not released into the air, to generate a carbon metrics model for sterilization of water by wood-burning at step 44.

As an alternative to a water meter or survey, one may also base consumption on demographic data.

A solar powered electronic water meter may also be employed and, where cellular telephone service is available, the meter may be coupled to a cellular telephone to report water usage in a more efficient manner. Such telemetering would provide a high degree of reliability and minimal costs for dispatching individuals.

It is also contemplated that consumed filters, which could be provided with a chemical or mechanical mechanism indicating that a nominal use volume has been consumed may be collected and replacement filters provided. Filters may have a compartment or other mating structure for receiving replacement filter cartridges. Those cartridges may have built in meters indicating volume consumed. The number of such filters replaced may be used as the basis for auditing of use and carbon credit calculation.

All such use information is provided at step 42 for later assessment at step 40. Water usage information is then used to calculate the applicable number of carbon credits at step 46. Alternatively, the information may be transmitted electronically over the Internet by manual entry of the same into a computer system. Such calculation may be directly done by computer coupled to the telemetering system, for example, over the Internet. At step 48 carbon credit information is transmitted to or made accessible to an auditing authority, and after approval by the authority that the appropriate criteria have been met, saved to memory. At step 48, a ledger is maintained and periodically updated as water consumption data is collected and processed.

The ledger is then used as the basis for trading, for example electronic trading, of carbon credits. In accordance with one embodiment of the invention, such electronic trading may be implemented by having dedicated sub ledgers, each dedicated to a particular contractual carbon credit contract. At the same time, electronic banking may be coupled to the ledgers resulting in electronic cash transfers in real time.

Further to the preliminary assessment detailed above, overall costs for the life of an installation, or some shorter but substantial period of time, as well as the carbon credits generated are assessed at step 40. Overall viability is judged at step 52. The measured viability obtained at step 52 is tested against a standard at step 54. If the project meets the standard, deliverables continue to be sent or new installation installed at step 56. If not, the project is terminated at step 58.

In accordance with the invention, it is contemplated that the costs and benefits, collected at step 40 and assessed at step 52, are used to develop a better consumption metrics model at step 60. The new consumption metrics are then used as step 62 to improve the application of consumption metrics at step 24 during subsequent operations.

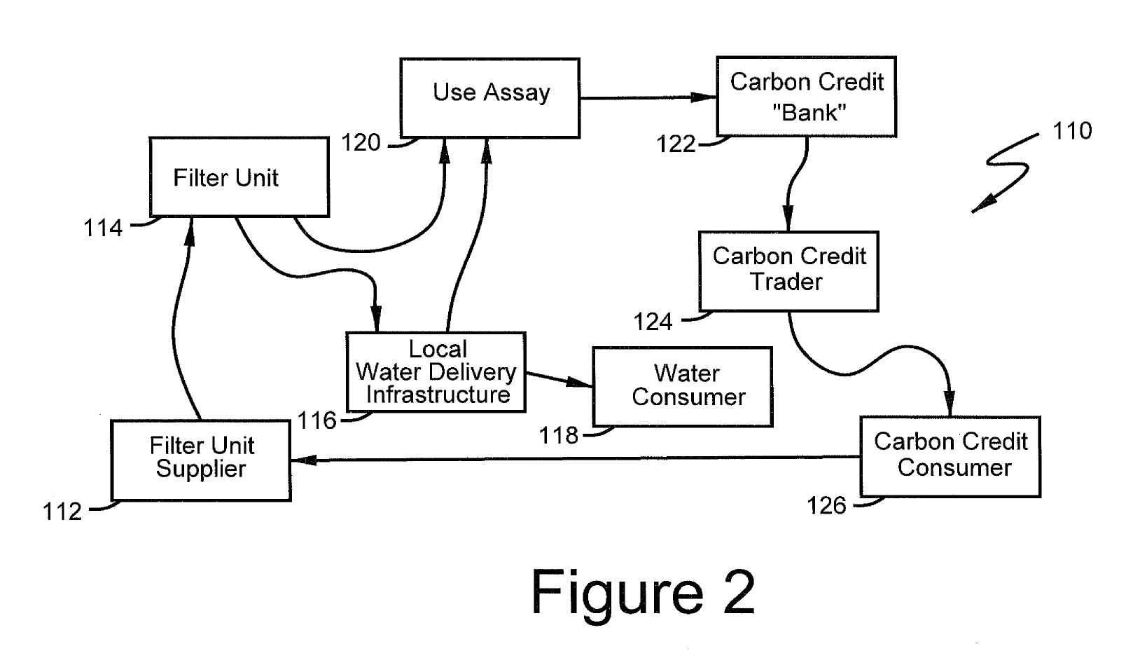

Referring to FIG. 2, the infrastructure 110 for implementing the inventive system is illustrated. The filter unit supplier 112 provides filter units 114 and optionally replacement filters for shipment to and installation at water delivery infrastructure 116. Water is thus made available to consumer 118.

Periodically use is recorded in a database 120. The same may be measured by the number of filters consumed. Such information is then sent to a carbon credit bank 122, which provides information to a trader 124 who liquidates the same with the carbon credit consumer 126 who provides funds to build the unit supplier 112. This information is consolidated in a semi-annual monitoring report. This report is audited by an international UNFCCC accredited auditor. The verification report and monitoring report are submitted to the Gold Standard or CDM for technical review. After this review, carbon credits are issued to the Project Proponent (us) and we then sell them to carbon credit consumer.

Presently, the Gold Standard is believed to be the most appropriate mechanism for the inventive method, because of the recently approved update to its cook stove methodology to include an explicit application for water technologies. It is most appropriate because of its focus on sustainable programs that deliver broader development outcomes. The methodology that allows water is now in both GS and CDM. This application is most consistent with the inventive objectives of reducing the need for fuel wood consumed required for water boiling (as a purification technique) to the introduction of new zero-emission filter technology that treats water. Moreover, the timeline to registration is also more favorable.

Table 1 includes the detailed project cycle for CDM and Gold Standard projects with associated timelines. What is presented in Table 1 is the best case scenario and assumes that there is an existing methodology and no validation or regulatory delays. In addition, this timeline is designed to be used as a guideline for planning. Differences in methodologies used, variation in timelines included in the validator contract, and delays are likely and should be taken into account.

It is also noted that in accordance with the present invention the methodology contemplates the pursuit of both the carbon credit track and the Gold Standard sustainability track simultaneously, on account of the large identity between the tasks and documentation required, as well as the other deliverables associated with the work, and the greater likelihood that following such procedures is likely to result in prompt sale of credits at the most favorable rates.

A variety of filters may be used in accordance with the method of the present invention. For example, a suitable water purification filter may be a point-of-use microbial water treatment system that can filter up to 18,000 liters of water over a three year period. Such a system employs hollow fiber membrane filters and, optionally, a chlorine chamber to prevent biofueling. Such a filter-based water purification unit should meet EPA water quality standards of a minimum 6-log reduction/inactivation of bacteria, 4-log reduction/inactivation of viruses, and 3-log reduction/inactivation of protozoan cysts. By surveying use by any method and thus determining the carbon credits earned may also be built into a filtering system adapted to receive simple filtering cartridges.

In accordance with the invention, any commercial filter may be used.

Such filter is a clean technology and requires no electricity or additional consumables beyond the unit itself making it a viable technology for the carbon market. However, the same likely requires full unit replacement after a period of about three years.

Revenue from carbon credits is contingent on annual verification of daily use and functioning of filter-based water purification units. A portion of the revenue realized may be put toward regular maintenance as well as replacement of the units and with current technology. If units can be repaired or restored without full replacement, costs decline and profit increases. The same may be achieved using replaceable filters.

In comparison, a refurbishable or repairable model of filter-based water purification would have more stable maintenance, repair and replacement costs annually, decrease volatility in capital requirements and alleviate fluctuating demand for production.

While illustrative embodiments of the invention have been described, it is noted that various modifications will be apparent to those of ordinary skill in the art informed by the above description and drawings. Such modifications are within the scope of the invention which is limited and defined only by the following claims.

What is claimed is:

1. A method for reducing the carbon footprint of a community by implementation of a water filter project, comprising:
(a) assessing the viability of a filter system to determine the acceptability of said filter system for implementation in a community as a substitute for the sterilization of water by boiling;
(b) transporting a filter system to said community;
(c) installing said filter system;
(d) operating said filter system;
(e) monitoring the volume of water produced by said filtering system and generating use data;
(f) communicating use data to a database;
(g) calculating the volume of carbon credits associated with said use data;
(h) communicating carbon credits to a consumer of carbon credits; and
(i) transferring funds from said consumer to a person or persons providing and installing said filter system.

2. A method as in claim 1, wherein the assessment of the viability of the filter system to determine the acceptability of said filter system for implementation in a community as a substitute for the sterilization of water by boiling comprises assessment of initial cost, service cost, unit life and system lifespan in volume of water produced.

3. A method as in claim 1, wherein said monitoring of the volume of water produced by said filtering system and generating use data is performed by a mechanical water meter.

4. A method as in claim 1, wherein said assessment of the viability of a filter system to determine the acceptability of said filter system for implementation in a community as a substitute for the sterilization of water by boiling conducts said assessment on the basis of community metrics such as population, accessibility, existing water delivery infrastructure, with reference to community model metrics and profitability associated therewith.

5. A method as in claim 1, wherein said monitoring of the volume of water produced by said filtering system and generating use data is performed by a telemetering subsystem.

6. A method as in claim 1, further comprising monitoring installation and maintenance costs and carbon credits generated to generate cost and carbon credit information, and communicating costs and carbon credit information to a cost and carbon credit information database.

7. A method as in claim 6, wherein said cost and carbon credit information database is communicated to information technology infrastructure associated with a carbon credit trading facility.

8. A method as in claim 6, wherein said cost and carbon credit information database is communicated to or resident in a computing device operated by software which assesses the value of carbon credits produced and compares the same to a threshold based on said cost information and generates a decision as toward whether to continue operation of said project.

9. A method as in claim 6 wherein said cost and carbon credit information database is communicated to or resident in a computing device operated by software which assesses the value of carbon credits produced and compares the same to a threshold based on said cost information and calculates adjustments to said community model metrics.

10. A method as in claim 9, wherein said adjusted community model metrics are used in subsequent assessment of the viability of filter systems to determine the acceptability of said filter systems for implementation in a community as a substitute for the sterilization of water by boiling.

11. A method as in claim 1, wherein said filter system comprises a compartment or other mating structure for receiving replacement filter cartridges.

12. A method as in claim 1, wherein the filter system uses a point-of-use microbial water treatment filter that can treat up to 18,000 liters of water over a three year period.

13. A method as in claim 12, wherein the filter employs hollow fiber membrane filters.

14. A method as in claim 13, wherein the filter functions to meet EPA water quality standards of a minimum 6-log reduction/inactivation of bacteria, 4-log reduction/inactivation of viruses, and 3-log reduction/inactivation of protozoan cysts.
